(19) United States
(12) Patent Application Publication
(10) Pub. No.: US 2009/0325503 A1
(43) Pub. Date: Dec. 31, 2009

(54) RADIO TERMINAL DEVICE, SEMICONDUCTOR DEVICE AND COMMUNICATION SYSTEM

(75) Inventor: Shigeto Tamazawa, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Tokyo (JP)

(21) Appl. No.: 12/478,470

(22) Filed: Jun. 4, 2009

(30) Foreign Application Priority Data
Jun. 30, 2008 (JP) 2008-169995

(51) Int. Cl. H04B 17/00

(52) U.S. Cl. 455/67.11

(57) ABSTRACT

A radio terminal device measures communication environment information on communication environments with base stations, then changes, when receiving a request from a connection destination base station among the base stations to regularly report the communication environment information with a predetermined response period, a measurement interval for the communication environment information according to the response period, and informs the connection destination base station of the measured communication environment information using a radio signal.

### CROSS-REFERENCE TO RELATED APPLICATIONS

This application is based upon and claims the benefit of priority of the prior Japanese Patent Application No. 2008-169995, filed on Jun. 30, 2008, the entire contents of which are incorporated herein by reference.

### FIELD

The embodiments discussed herein are related to a radio terminal device, a semiconductor device and a communication system.

### BACKGROUND

An advisory report “802.16e-Mobile WiMAX” defined by IEEE (Institute of Electrical and Electronic Engineers) specifies a communication between a base station and a radio terminal device. This advisory report describes a feedback function as a method for the base station to obtain communication environment information on the radio terminal device side. The communication environment information sets reported from the radio terminal device to the base station in execution of the feedback include RSSI (Received Signal Strength Indication) and CINR (Carrier to Interference and Noise Ratio).

These information sets can be obtained when the radio terminal device measures signals from the base station. The advisory report specifies a process for calculating an average and standard deviation of the RSSI and the CINR but does not describe an interval for measuring the signals.

The RSSI and the CINR are used also, for example, in performing handover. Specifically, the radio terminal device measures signals from surrounding base stations and switches, when there presents a base station capable of providing a better communication environment than that provided by a currently communicating base station, its connection destination to the new base station. That is, in order to perform handover, the radio terminal device always has to measure the signals from the surrounding base stations so as to perform the measurement management. Therefore, regardless of the presence or absence of feedback requests from base stations, the radio terminal device has to measure the signals from the connection destination base station and from the surrounding base stations.

To lessen a control burden of a mobile station or a base station, one conventional method measures a communication quality of a currently communicating channel at at least one of the mobile station and the base station, and changes a communication quality measurement interval according to the measurement results (for example, Japanese Laid-open Patent Publication No. 05-308330).

Another conventional method measures an electric field strength or quality of a down wave at a mobile station and reports the measurement results to a radio base station to evaluate an interference state at the radio base station (for example, Japanese Laid-open Patent Publication No. 08-237729).

When a measurement interval of a radio terminal device is longer than a response period specified in a feedback request from a base station, the radio terminal device fails to perform measurement processing between the previous feedback response and the next feedback response. As a result, the radio terminal device sends old and low-accuracy measurement information to the base station. In this case, an adverse effect is exerted upon the communication between the base station and the radio terminal device.

When the measurement interval is too short, a load of a processor of the radio terminal device increases and as a result, the communication speed is deteriorated.

### SUMMARY

According to one aspect of the present invention, a radio terminal device includes: a measuring unit which measures communication environment information on communication environments with base stations; a measurement interval changing unit which, when receiving a request from a connection destination base station among the base stations to regularly report the communication environment information with a predetermined response period, changes a measurement interval for the communication environment information according to the response period; and a radio signal processor which informs the connection destination base station of the measured communication environment information using a radio signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a block diagram of a radio terminal device according to the present embodiment;

FIG. 2 is a flow chart illustrating a process carried out by the radio terminal device (No. 1);

FIG. 3 is a flow chart illustrating a process carried out by the radio terminal (No. 2);

FIG. 4 illustrates a flow of frames;

FIGS. 5A and 5B illustrate states of change processing of a measurement interval; and

FIG. 6 illustrates a state where regular feedback is completed.

### DESCRIPTION OF EMBODIMENT(S)

Embodiments of the present invention will be described below with reference to the accompanying drawings, wherein like reference numerals refer to like elements throughout.

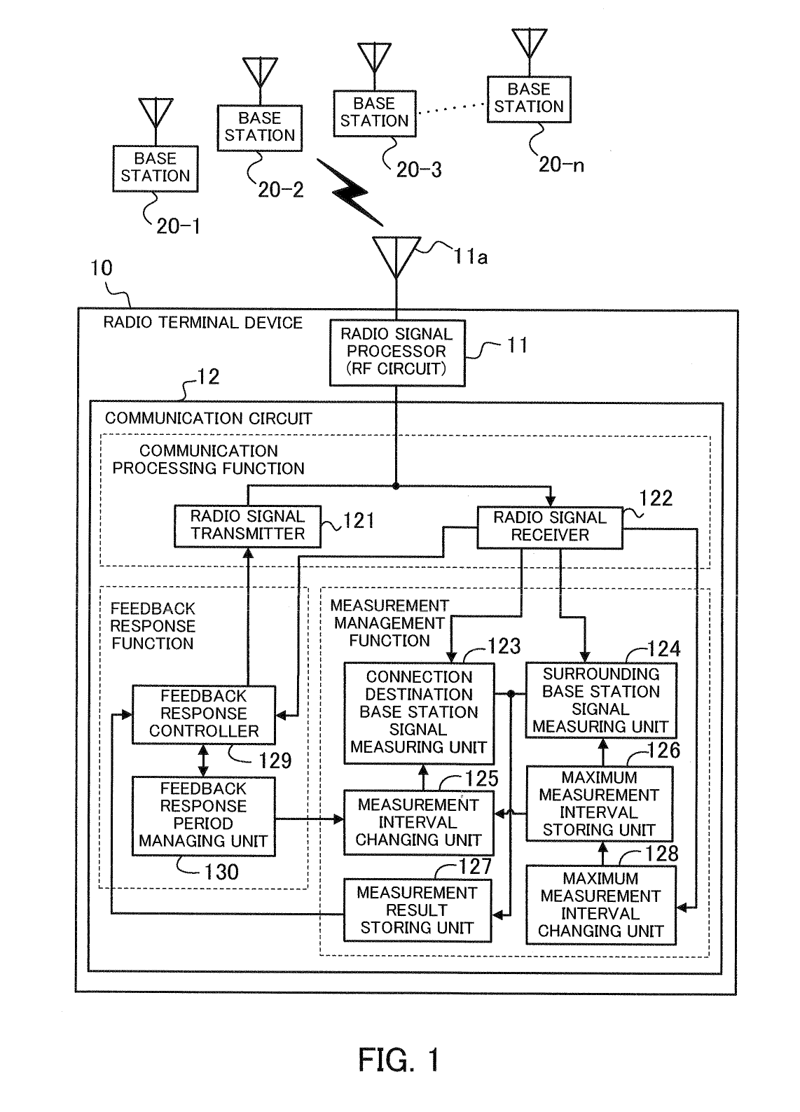

FIG. 1 is a block diagram of a radio terminal device 10 according to the present embodiment.

The radio terminal device 10 according to the present embodiment is, for example, portable telephones or notebook PCs (Personal Computers) based on IEEE802.16e. The radio terminal device 10 has a radio signal processor (RF (Radio Frequency) circuit) 11 and a communication circuit 12.

The radio signal processor 11 exchanges radio signals with base stations 20-1, 20-2, 20-3, . . . , 20-n through an antenna 11a. Further, the radio signal processor 11 changes a transmission power according to a distance from each of the base stations 20-1 to 20-n.

The communication circuit 12 is, for example, a CPU (Central Processing Unit). The communication circuit 12 has a communication processing function, a measurement management function and a feedback response function. The communication processing function is realized, for example, by a physical layer, and the measurement management function and the feedback response function are realized, for example, by a media access control (MAC) layer. The respective functions are realized, for example, by the following function blocks.

The communication processing function is realized, for example, by a radio signal transmitter 121 and a radio signal receiver 122.

The radio signal transmitter 121 modulates information to send to the base stations 20-1 to 20-n.

The radio signal receiver 122 demodulates, according to a modulation scheme, a signal received through the radio signal processor 11 or specifies a source base station of the signal from a cell ID included in the received signal.

The measurement management function is realized, for example, by a connection destination base station signal measuring unit 123, a surrounding base station signal measuring unit 124, a measurement interval changing unit 125, a maximum measurement interval storing unit 126, a measurement result storing unit 127 and a maximum measurement interval changing unit 128.

The connection destination base station signal measuring unit 123 measures the information on the communication environment with a currently connected base station among the base stations 20-1 to 20-n. The information on the communication environment includes RSSI, CINR and a transmission power of the radio terminal device 10.

The surrounding base station signal measuring unit 124 measures the information on the communication environment with a surrounding base station other than the currently connected base station.

The measurement interval changing unit 125 changes, when receiving a request (hereinafter referred to as a regular feedback request) from the connection destination base station to regularly report the communication environment information with a predetermined response period, a measurement interval in the connection destination base station signal measuring unit 123 according to the response period.

The maximum measurement interval storing unit 126 previously stores a maximum measurement interval. The maximum measurement interval is, for example, a measurement interval which is set by a carrier side and which is minimally required to maintain communication. Specifically, the maximum measurement interval is a measurement interval providing a measurement accuracy required in performing handover.

The measurement result storing unit 127 stores the results measured by the connection destination base station signal measuring unit 123 and by the surrounding base station signal measuring unit 124.

The maximum measurement interval changing unit 128 changes the maximum measurement interval according to a modulation scheme used in the communication with the base stations 20-1 to 20-n. Examples of the modulation scheme include QPSK (Quadrature Phase Shift Keying), 16 QAM (Quadrature Amplitude Modulation) and 64 QAM. When the modulation scheme is QPSK used in an easily deteriorating communication environment, the maximum measurement interval changing unit 128 reduces the maximum measurement interval whereas when the modulation scheme is 16 QAM and 64 QAM having a large amount of information, the maximum measurement interval changing unit 128 extends the maximum measurement interval.

The feedback response function is realized, for example, by a feedback response controller 129 and a feedback response period managing unit 130.

The feedback response controller 129 detects, based on the signals received by the radio signal receiver 122, a regular feedback request from a connection destination base station, an irregular feedback request, and a response period of a regular feedback or an execution period of a regular feedback. And then, the feedback response controller 129 obtains, when detecting the regular feedback request from the connection destination base station or the irregular feedback request, the communication environment information stored in the measurement result storing unit 127 and informs the radio signal transmitter 121 of the communication environment information.

The feedback response period managing unit 130 manages a plurality of regular feedback response periods according to a plurality of communication environment information sets.

The base stations 20-1 to 20-n send the regular feedback request or the irregular feedback request to the radio terminal device 10 and specifies the response period and execution period of the regular feedback. And then, the base stations 20-1 to 20-n send back to the radio terminal device 10 a handover request or a transmission power change request based on the communication environment information measured by the radio terminal device 10.

Hereinafter, operations of the radio terminal device 10 according to the present embodiment will be described with reference to a flowchart.

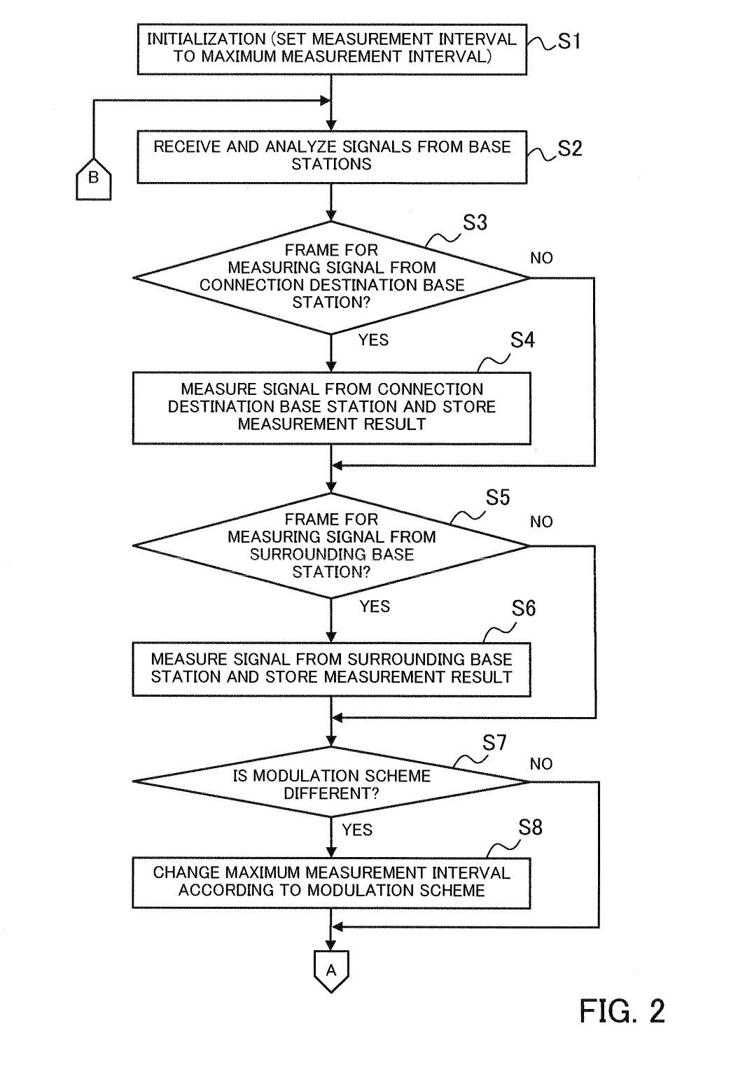

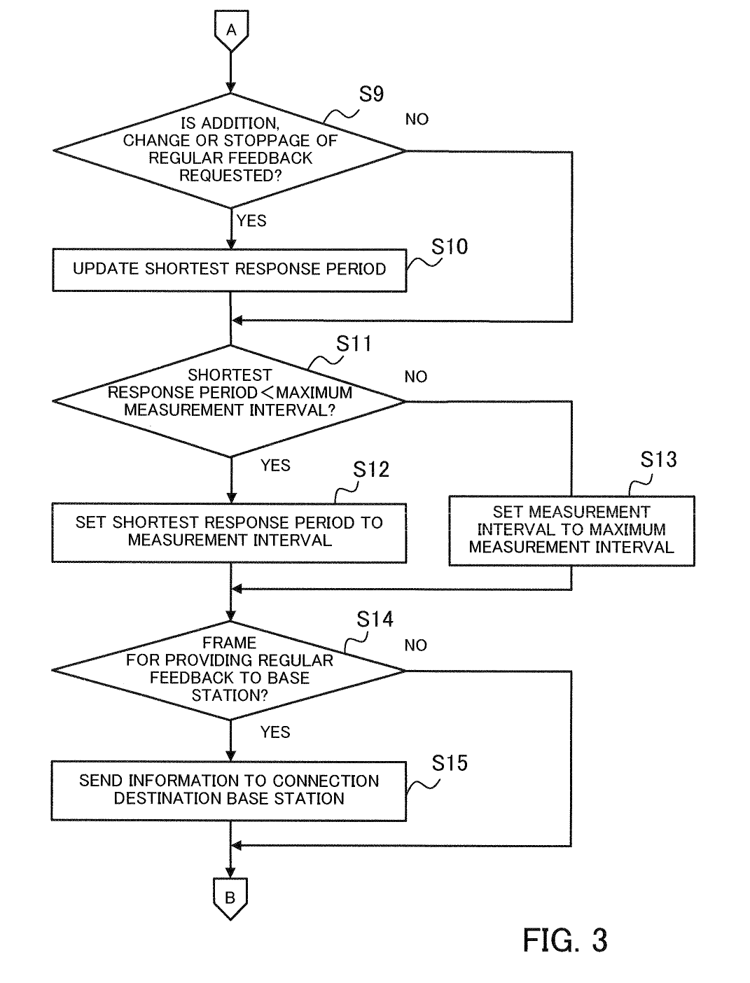

FIGS. 2 and 3 are flow charts illustrating a process carried out by the radio terminal device 10 according to the present embodiment.

At first, initialization is performed (step S1). Here, the surrounding base station signal measuring unit 124 and the measurement interval changing unit 125 read a maximum measurement interval stored in the maximum measurement interval storing unit 126. And then, the measurement interval changing unit 125 sets a measurement interval in the connection destination base station signal measuring unit 123 to the maximum measurement interval.

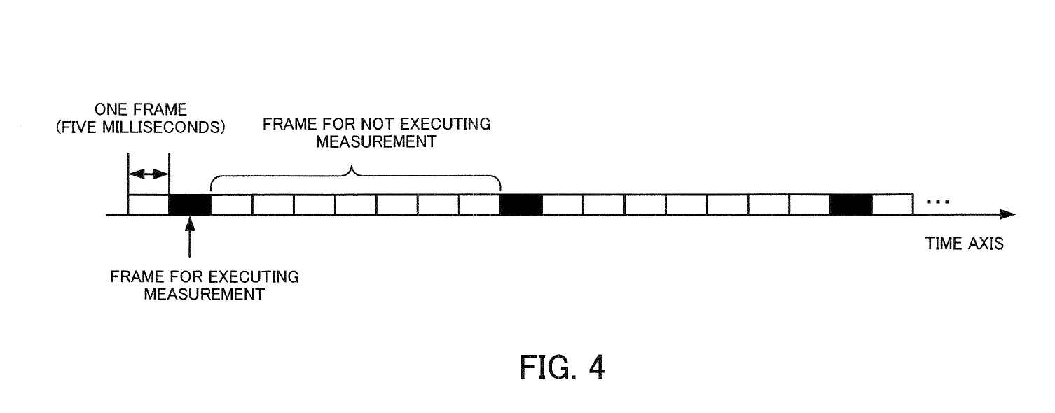

FIG. 4 illustrates a flow of frames.

The horizontal axis represents a time axis. In the Mobile WiMAX standard, a communication is performed in units of frames. One frame has, for example, a duration of five milliseconds. Here, FIG. 4 illustrates a case where the maximum measurement interval is set to eight frames. A frame for executing measurement is indicated by a black frame and a frame for not executing measurement is indicated by a white frame.

Since the surrounding base stations other than the connection destination base station send no regular feedback request to the radio terminal device 10, the radio terminal device 10 sets the measurement interval to the maximum measurement interval. As a result, a load of the CPU can be suppressed.

When the maximum measurement interval is set, the radio signal receiver 122 receives signals from the base stations 20-1 to 20-n through the radio signal processor 11 and analyzes the signals (step S2). Here, the radio signal receiver 122 demodulates a signal according to a modulation scheme of the signal or specifies a base station as a source base station from a cell ID included in the received signal.

Next, the connection destination base station signal measuring unit 123 determines, based on analysis results by the radio signal receiver 122, whether the signal is sent from the connection destination base station and a frame of the signal is the frame for executing measurement as illustrated in FIG. 4 (step S3). In the case of “YES” at step S3, the connection destination base station signal measuring unit 123 measures the information (RSSI or CINR) on the communication environment with the connection destination base station. And then, the connection destination base station signal measuring unit 123 stores the measurement results in the measurement result storing unit 127 (step S4).

After the process at step S4 or in the case of “NO” at step S3, the process goes to step S5. In the process at step S5, the surrounding base station signal measuring unit 124 determines, based on the analysis results by the radio signal receiver 122, whether the signal is sent from a surrounding base station other than the connection destination base station and a frame of the signal is the frame for executing measurement as illustrated in FIG. 4 (step S5).

In the case of “YES” at step S5, the surrounding base station signal measuring unit 124 measures the information on the communication environment with the surrounding base station. And then, the surrounding base station signal measuring unit 124 stores the measurement results in the measurement result storing unit 127 (step S6).

After the process at step S6 or in the case of “NO” at step S5, the process goes to step S7. In the process at step S7, the maximum measurement interval changing unit 128 detects a modulation scheme of a signal received by the radio signal receiver 122 and determines whether the detected modulation scheme is a different one (step S7). In the case of “YES” at step S7, the maximum measurement interval changing unit 128 changes the maximum measurement interval according to the modulation scheme of the received signal (step S8).

For example, When the modulation scheme is QPSK used in an easily deteriorating communication environment, the maximum measurement interval changing unit 128 reduces the maximum measurement interval whereas when the modulation scheme is 16 QAM and 64 QAM having a large amount of information, the maximum measurement interval changing unit 128 extends the maximum measurement interval.

At this time, the maximum measurement interval changing unit 128 stores the changed maximum measurement interval in the maximum measurement interval storing unit 126. The maximum measurement interval stored in the maximum measurement interval storing unit 126 is used in the measurement interval changing unit 125 and the surrounding base station signal measuring unit 124. Thereby, the measurement interval changing unit 125 can set the measurement interval according to the modulation scheme.

After the process at step S8 or in the case of “NO” at step S7, the process goes to step S9.

In the process at step S9, the feedback response controller 129 determines, based on the signal received by the radio signal receiver 122, whether addition, change or stoppage of the regular feedback is requested by the regular feedback request from the connection destination base station (step S9). In the case of “YES” at step S9, the feedback response controller 129 updates the response period or the execution period based on the information included in the received signal. And then, the feedback response controller 129 sends the changes of the response period to the feedback response period managing unit 130. The feedback response period managing unit 130 updates the shortest response period among the response periods of the currently executed regular feedbacks (step S10).

Next, the measurement interval changing unit 125 determines whether the shortest response period among the response periods of the regular feedbacks managed by the feedback response period managing unit 130 is shorter than the maximum measurement interval stored in the maximum measurement interval storing unit 126 (step S11).

In the case of “YES” at step S11, the measurement interval changing unit 125 sets the shortest response period to the measurement interval in the connection destination base station signal measuring unit 123 (step S12).

Thus, when the connection destination base station among the base stations 20-1 to 20-n sends to the radio terminal device 10 a regular feedback request with a short response period to request high-accuracy measurement information on the communication environment, the radio terminal device 10 sets the shortest response period to a measurement interval. As a result, high-accuracy measurement information can be obtained.

In the case of “NO” at step S11, the measurement interval changing unit 125 sets the measurement interval in the connection destination base station signal measuring unit 123 to a maximum measurement interval based on the maximum measurement interval stored in the maximum measurement interval storing unit 126 (step S13).

Thus, when the base stations 20-1 to 20-n request no high-accuracy measurement information, the radio terminal device 10 sets the measurement interval to the maximum measurement interval. As a result, a load of the CPU can be suppressed.

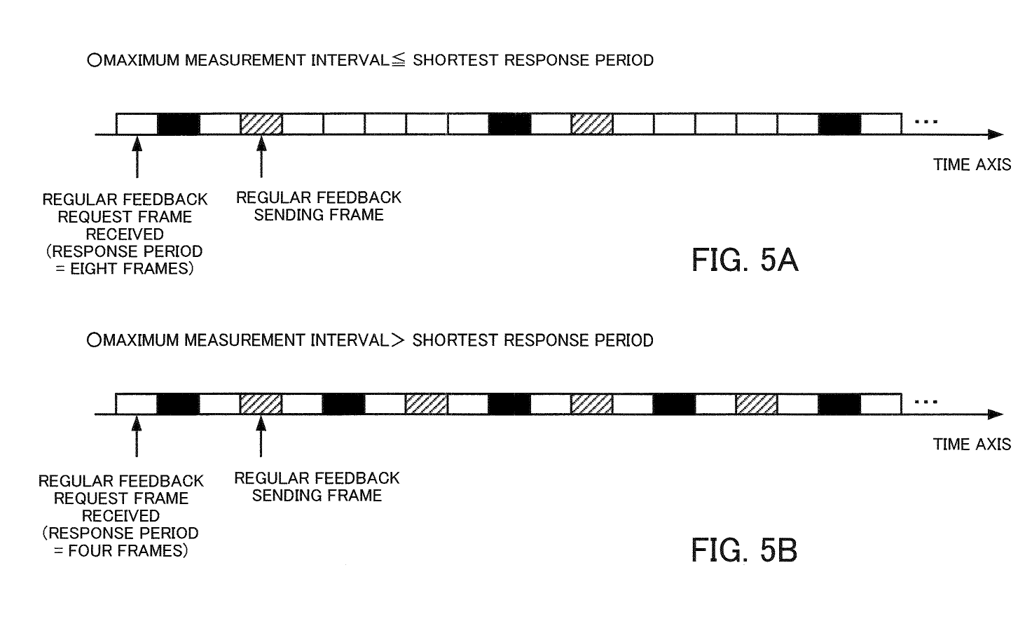

FIGS. 5A and 5B illustrate states of change processing of the measurement interval. FIG. 5A illustrates a state where the shortest response period is longer than the maximum measurement interval, and FIG. 5B illustrates a state where the shortest response period is shorter than the maximum measurement interval.

The horizontal axis represents a time axis. One frame has, for example, a duration of five milliseconds. Here, FIGS. 5A and 5B illustrate cases where the maximum measurement interval is set to eight frames. A frame for executing measurement is indicated by a black frame, a frame for not executing measurement is indicated by a white frame, and a frame for sending regular feedbacks is indicated by a shaded frame. In addition, a head frame is used as a regular feedback request frame.

In the regular feedback request frame, the response period or execution period of the regular feedback is specified.

When, in the regular feedback request frame received, the response period is specified to eight frames as illustrated in FIG. 5A, the maximum measurement interval is equal to the shortest response period. Therefore, the measurement interval changing unit 125 sets the measurement interval to the maximum measurement interval.

When, in the regular feedback request frame received, the response period is specified to four frames as illustrated in FIG. 5B, the maximum measurement interval is longer than the shortest response period. Therefore, the measurement interval changing unit 125 sets the measurement interval to four frames as the shortest response period.

After the setting of the measurement interval, the feedback response controller 129 determines, with reference to the response period of the regular feedback managed by the feedback response period managing unit 130, whether a frame of the received signal is a frame for providing regular feedbacks to the connection destination base station (a frame for sending regular feedbacks illustrated in FIGS. 5A and 5B) (step S14).

In the case of “YES” at step S14, the feedback response controller 129 informs the radio signal transmitter 121 of the measurement results such as RSSI and CINR stored in the measurement result storing unit 127, and the radio signal transmitter 121 sends the information to the connection destination base station through the radio signal processor 11 (step S15). Thereafter, the above processes from step S2 to step S15 are repeated.

The connection destination base station that receives the information on the communication environment sends back to the radio terminal device 10 a handover request or a transmission power increase request based on the communication environment information measured by the radio terminal device 10.

When no other currently executed regular feedback is present after completion of the execution period of the regular feedback, the measurement interval changing unit 125 resets the measurement interval to the maximum measurement interval although its illustration is omitted in FIGS. 2 and 3.

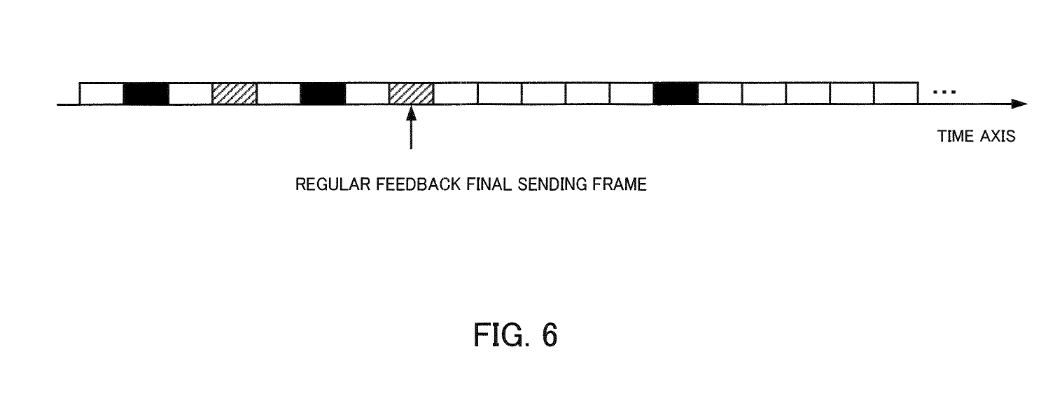

FIG. 6 illustrates a state where the regular feedback is completed.

The horizontal axis represents a time axis. Here also, FIG. 6 illustrates a case where the maximum measurement interval is set to eight frames. A frame for executing measurement is indicated by a black frame, a frame for not executing measurement is indicated by a white frame, and a frame for sending regular feedbacks is indicated by a shaded frame.

When the regular feedback with the response period of four frames is completed, the measurement interval changing unit 125 changes the measurement interval from four frames to eight frames as the maximum measurement interval as illustrated in FIG. 6. As a result, a load of the CPU can be suppressed.

As described above, in the present embodiment, when receiving the regular feedback request from the connection destination base station among the base stations 20-1 to 20-n, the measurement interval is changed according to the response period. As a result, a load of the CPU in the radio terminal device 10 can be suppressed as well as high-accuracy measurement information can be reported to the connection destination base station.

In the present embodiment, the radio terminal device 10 may be a mobile station or a fixed station.

A load of a processor of a radio terminal device can be suppressed and high-accuracy measurement information can be reported to base stations if necessary.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions and alterations could be made hereto without departing from the spirit and scope of the invention.

What is claimed is:

1. A radio terminal device, comprising:
a measuring unit which measures communication environment information on communication environments with base stations;
a measurement interval changing unit which, when receiving a request from a connection destination base station among the base stations to regularly report the communication environment information with a predetermined response period, changes a measurement interval for the communication environment information according to the response period and
a radio signal processor which informs the connection destination base station of the measured communication environment information using a radio signal.

2. The radio terminal device according to claim 1, wherein:
the measurement interval changing unit compares a pre-stored maximum measurement interval with the response period and changes the measurement interval, the change process being performed such that when the maximum measurement interval is longer than the response period, the response period is set to the measurement interval whereas when the maximum measurement interval is shorter than the response period, the maximum measurement interval is set to the measurement interval.

3. The radio terminal device according to claim 2, wherein:
the measurement interval changing unit sets the measurement interval to the maximum measurement interval when receiving no request from the connection destination base station to regularly report the communication environment information.

4. The radio terminal device according to claim 2, wherein:
the measurement interval changing unit sets, to the maximum measurement interval, the measurement interval for measuring the communication environment information on the communication environment with the base station other than the connection destination base station.

5. The radio terminal device according to claim 1, further comprising a maximum measurement interval changing unit which changes the maximum measurement interval according to a modulation method used in the communication with the base stations.

6. The radio terminal device according to claim 5, wherein:
the maximum measurement interval changing unit reduces the maximum measurement interval when the modulation method is used in an easily deteriorating communication environment.

7. The radio terminal device according to claim 2, wherein:
the measurement interval changing unit uses, as the response period for comparing with the maximum measurement interval, the shortest response period among the respective response periods in a plurality of regular reports of the plurality of communication environment information sets.

8. A semiconductor device, comprising:
a measuring unit which measures communication environment information on communication environments with base stations and
a measurement interval changing unit which, when receiving a request from a connection destination base station among the base stations to regularly report the communication environment information with a predetermined response period, changes a measurement interval for the communication environment information according to the response period.

9. A communication system, comprising:
a plurality of base stations and
a radio terminal device which measures communication environment information on communication environments with the base stations, which when receiving a request from a connection destination base station among the base stations to regularly report the communication environment information with a predetermined response period, changes a measurement interval for the communication environment information according to the response period, and which informs the connection destination base station of the measured communication environment information using a radio signal.
